(19) United States
(12) Patent Application Publication
(10) Pub. No.: US 2004/0010543 A1
(43) Pub. Date: Jan. 15, 2004

(54) Cached resource validation without source server contact during validation

(76) Inventor: Steven Grobman, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/196,495

(22) Filed: Jul. 15, 2002

(51) Int. Cl. G06F 15/16; G06F 15/167

(52) U.S. Cl. 709/203; 709/206; 709/250; 709/213

(57) ABSTRACT

A document may be received over a network that contains a link to a resource. Various contexts, including Internet browsers, can operate more effectively, and make better use of available bandwidth, by caching network resources so that repeated requests for cached resources can be satisfied from a local cache and avoid a duplicative transfer from a server. Instead of utilizing typical cache operations, such as taught in Request For Comments (RFC) 2616, where the server hosting the resource is queried to resolve cache correctness, instead a link to a resource is constructed so that it contains all information necessary to make a cache correctness decision without having to query the server hosting the linked resource. In addition, the link may be constructed so that the cache determination is made with respect to the contents of the linked resource, rather than with respect to metadata about the resource, e.g., name, creation date, location, etc.

### FIELD OF THE INVENTION

The invention generally relates to caching network resources, and more particularly to constructing links to network resources such that the link comprises information sufficient to make a cache hit-or-miss determination without having to contact a server hosting a network resource.

### BACKGROUND

In a typical client-server environment, a server may provide a client with a document. By placing a link to the resource in the document, the structure of the document can be received by the client without the client having to immediately access the linked resource. Delaying access also allows the client to elect not to access the resource at all, or to determine whether the client already has the resource in a cache, e.g., a local repository storing accessed resources. Use of a cache can greatly reduce data transfer requirements, which is very important in many contexts, a common one being limited bandwidth links to a network, such as a dialup connection.

For example, in the Internet context, the HyperText Transport Protocol (HTTP) is the standard protocol by which information is transported over Transmission Control Protocol/Internet Protocol (TCP/IP) compatible networks, such as the Internet. HTTP is called a transport protocol since information is transported according to its specifications, and it operates in a request-response fashion where information is sent by a server in response to a request made by a client. A common use today of HTTP is transporting documents formatted according to a markup language, such as the HyperText Markup Language (HTML), the Standard Generalized Markup Language (SGML), the eXtensible Markup Language (XML), or other description language. The HTTP protocol is described in the Network Working Group Request for Comments (RFC) 2616, dated June 1999, titled “Hypertext Transfer Protocol—HTTP/1.1.”

A document, by way of HTTP, may provide access to a resource. A resource may be a graphic image, sound file, movie, animation, streaming video, application program, program object, data file, web page, database, or other content having a location described by a Uniform Resource Locator (URL) of the form <protocol>:<server>/<resource>, where <protocol> refers to a protocol, e.g., HTTP, File Transfer Protocol (FTP), etc. to use to retrieve the identified <resource> from the <server>. URLs are described in RFC 1738, dated December 1994, titled “Uniform Resource Locators (URL).” FIG. 1, for example, illustrates a conventional prior art HTML link 100 to an image resource named “GOLDFISH.JPG” 102 that is located on a server located at SERVER-ADDRESS 104.

When processing a received document, such as a web page, containing a link to a resource, such as the FIG. 1 link to the image resource, cache checking is performed in accord with RFC 2616. RFC 2616 §13 states that to resolve whether the resource is present in a local cache, a validation check is performed for equivalence between the cached resource and the resource of the server. In particular, when the client originally received a resource from a server, the server also provided validation data along with the resource. When the client later attempts to validate its cached version of the linked resource, the client makes a conditional request for the resource from the server that includes the client's validation data for the resource. The server checks its validation data against that provided by the client, and sends a response indicating whether the client's cache is valid, or sends the client the resource.

A significant limitation to conventional caching techniques, such as that described at length in RFC 2616, is that in order to validate the client's cached version of the linked resource, it is necessary to communicate with the server to obtain information about the linked resource so that the client can determine whether it already has a copy of the resource in its cache. And, it can take very little change in order to invalidate a cache entry. For example, in the Internet browser context, validation fails if the linked resource, e.g., an image file, has a different file name from that of the cached resource. Validation may also fail if the linked resource has a different URL from the cached resource. Thus, even if the cached and linked resources have the same content, a client may nonetheless have to maintain multiple copies of the resource.

### BRIEF DESCRIPTION OF THE DRAWINGS

The features and advantages of the present invention will become apparent from the following detailed description of the present invention in which:

FIG. 1 illustrates a conventional prior art HTML link to an image resource.

FIG. 2 illustrates an exemplary link according to one embodiment.

FIG. 3 illustrates an exemplary flowchart according to one embodiment for validating a cache against a received document containing a FIG. 2 link.

FIG. 4 illustrates a system according to one embodiment comprising a mail server and mail clients.

FIG. 5 illustrates a flowchart according to one embodiment of the FIG. 4 system for a mail client to process a mail message 414 and reply message.

FIG. 6 illustrates a flowchart according to one embodiment of the FIG. 4 system for the mail server to process a mail message and attachment send by a mail client, and a reply with duplicative attachment sent by another mail client.

FIG. 7 illustrates a suitable computing environment in which certain aspects of the invention may be implemented.

### DETAILED DESCRIPTION

A document may be received over a network that contains a link to a resource. Various contexts, including Internet browsers, can operate more effectively, and make better use of available bandwidth, by caching network resources so that repeated requests for cached resources can be satisfied from a local cache and avoid a duplicative transfer from a server. For this description, an Internet context is assumed, where a tag based document description language, e.g., HTML, XML, etc., is assumed used to describe a web page containing a link to a resource hosted by a server (which might not be the server providing the web page). It will be appreciated that illustrated embodiments will be applicable in other non-Internet contexts.

When a resource is initially and subsequently accessed, it is assumed caching techniques are employed to facilitate subsequent access to the resource. However, in illustrated embodiments, instead of a typical cache operation, such as in RFC 2616, where the server hosting the resource is queried to resolve cache correctness, instead a link to a resource it constructed so that is contains all information necessary to make a cache correctness decision without having to query the server hosting the linked resource. In addition, the link is constructed so that the cache determination is made with respect to the contents of the linked resource, rather than with respect to metadata about the resource, e.g., name, creation date, location, etc.

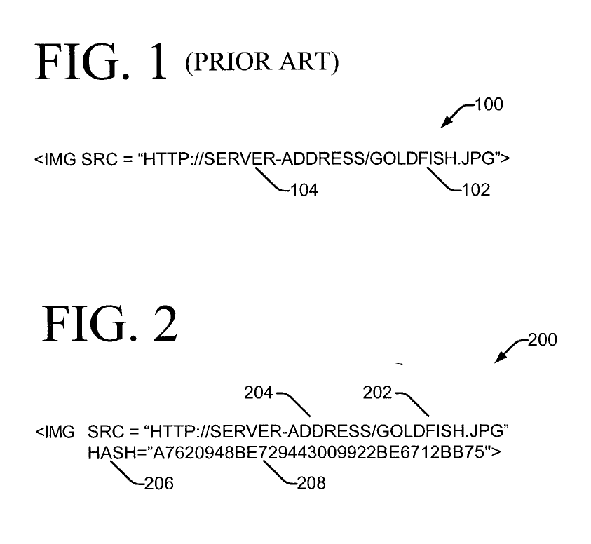

FIG. 2 illustrates an exemplary link 200 according to one embodiment. As with FIG. 1, the illustrated exemplary references a GOLDFISH.JPG 202 image resource located at SERVER-ADDRESS 204. However, in contrast with the conventional FIG. 1 embodiment, the FIG. 2 link 200 includes a hash value 206 defined within the link that includes a hash value 208 computed on the contents of the GOLDFISH.JPG image resource. With the hash value contained within the hash value, a client receiving a document, such as a web page, including the FIG. 2 link to the image resource, can use the hash value to determine a cache hit or miss without having to contact the server. It will be appreciated that the hash value can be statically or dynamically inserted into the document, and may be inserted by the server contacted by the client, or by an agent processing or filtering communication with the server.

Various hash encoding techniques may be employed to derive the hash value 208. For example, one well-known hashing technique is the MD5 hashing technique described in RFC 1321, dated April 1992, titled “The MD5 Message-Digest Algorithm.” Another well-known hashing technique is SHA-1 described in Federal Information Processing Standards (FIPS) Publication 180-1, dated May 1993, titled “Secure Hash Standard.” It will be appreciated that any of a variety of hash or other information processing analysis may be used to generate the hash value, so long as it is statistically unlikely that two different resources will result in the same hash value.

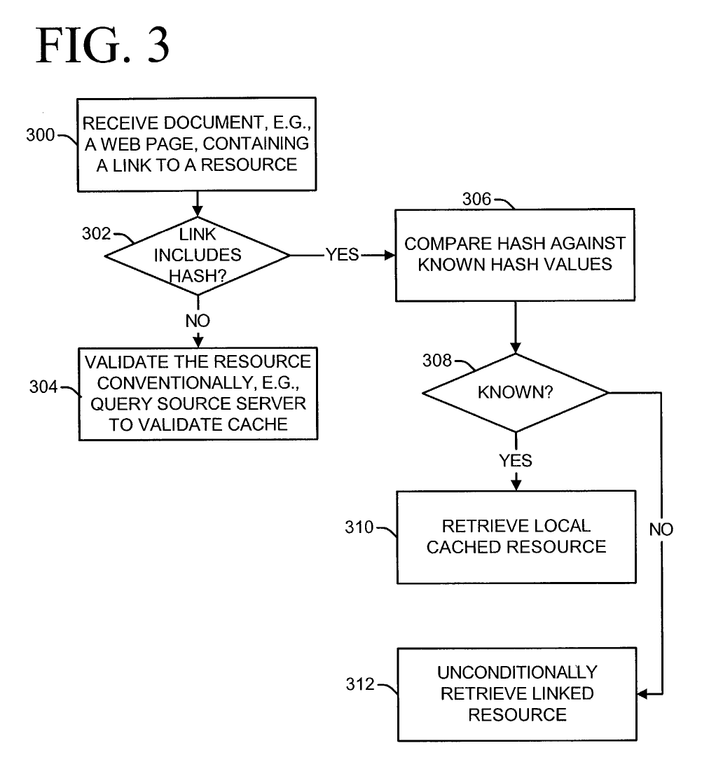

FIG. 3 illustrates an exemplary flowchart according to one embodiment for validating a cache against a received document containing a link to a resource, e.g., a FIG. 2 link 200.

After receiving 300 the document containing the link 200, a test is performed to determine if 302 the link contains an embedded hash (or other identifier) value 206. If not, then cache validation proceeds 304 conventionally, e.g., in accord with RFC 2616, resulting in the server that provided the document being queried to validate the cache. If 302 the link contained an embedded hash value, then the hash value 208 is compared 306 against known hash values. If 308 the hash is known, then the local cached resource is retrieved 310. If the hash is not known, then the linked resource is unconditionally retrieved from its source server; it is not necessary to validate with the source server before retrieval since the hash value is all that is required to know that the linked resource is not available locally. In the context of HTTP, if the hash is not known, instead of the conditional GET operation used in conventional cache validation, e.g., per RFC 2616, instead an unconditional GET operation is used since it is known before contacting the server that the resource is not present in the client's cache.

It will be appreciated that various data tracking techniques may be employed to store hash values in order to implement the comparison 306 of a received hash value against known hash values. For example, a database may be used to store received hash values. Note that in the illustrated embodiment, by associating a hash value (or other identifying value), it is no longer necessary for a client or server to track other validation data about a resource, e.g., a resource name, modification date, etc., as the hash value is all that is required to make a cache hit or cache miss determination. In addition, it does not matter from where a client receives a particular resource in order to validate a cache entry. For example, if the FIG. 2 “GOLDFISH.JPG” image resource was cached incident to communicating with a first server, and communication with a second server identifies a “FISH.JPG” image resource having the same hash value as “GOLDFISH.JPG”, a client can determine a cache hit even though the “FISH.JPG” image resource has a different name and a different origin server. In the illustrated embodiment, origin, file name, or other attributes of a resource are no longer relevant to making a cache determination.

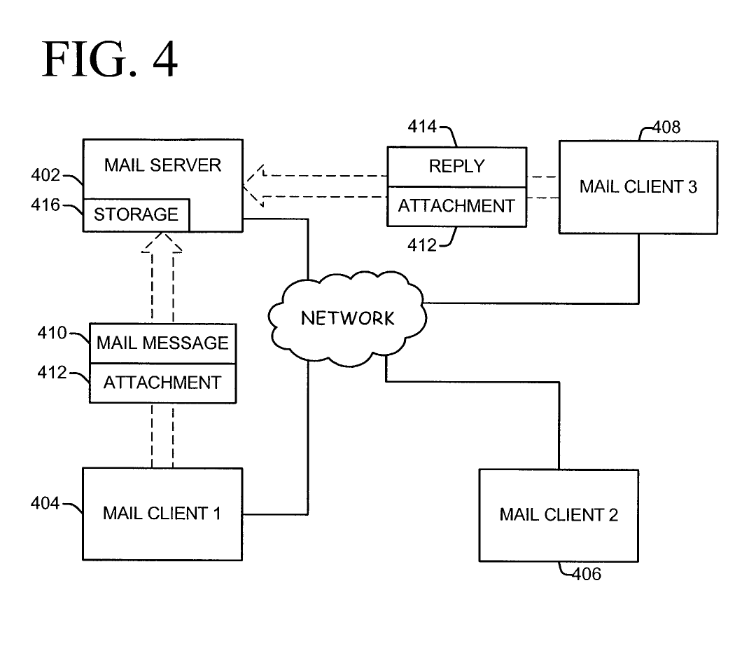

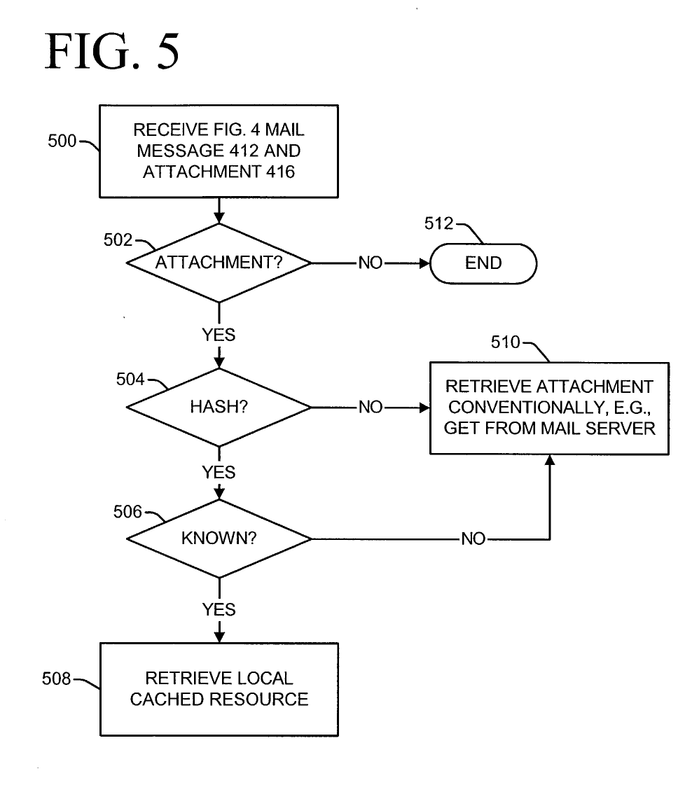

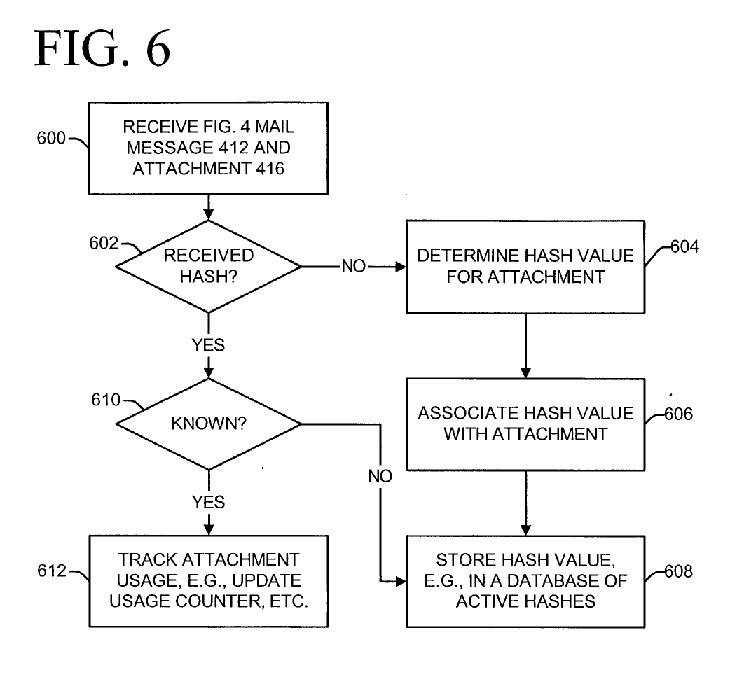

FIG. 4 illustrates a system 400 according to one embodiment comprising a mail server 402 and mail clients 404-408. Assume mail client 1 404 sends a mail message 410 with an attachment 412 to mail clients 2 and 3 406-408, and mail client 3 408 sends a reply 414 to all other message recipients 404-406 that includes a copy of the attachment 412 originally sent by mail client 1 404.

In a typical mail environment where the mail server 402 stores message attachments in a storage 416 until a recipient accesses the attachment, if the recipient accesses the attachment originally sent by mail client 1 404, the recipient obtains a copy of the attachment from the mail server. However, if the recipient subsequently accesses the attachment contained in the reply from mail client 3 410, the recipient obtains another copy of the attachment because it is considered a different attachment since it is associated with a different mail message. Such redundant attachment storage can be avoided by configuring attachment links to include a hash value (or other identifying value) for the attachment, and configuring mail clients to inspect associated hash values to determine whether a local copy of the attachment already exists.

Towards this end, FIG. 5 illustrates a flowchart according to one embodiment of the FIG. 4 system 400 for a mail client to process the mail message 414 and reply message 418.

When the mail client receives 500 mail message 414, it checks if 452 the message has an attachment. If so, the mail client looks for a hash value associated with the attachment. It will be appreciated that various techniques may be used to associate hash values with attachments, including embedding them into URLS as discussed above, as an e-mail header definition, incorporating the hash value into a MIME (Multipurpose Internet Mail Extensions) entry for the attachment, or the like.

If 504 the attachment has an associated hash value, a further check is performed to determine if 506 the hash value is known, indicating the attachment is locally available, e.g., in an attachment cache. If so, then the local attachment is retrieved 508 rather than retrieving from a mail server. If 504 there was no hash value associated with the attachment, which may occur for messages originating from a mail client and/or mail server not supporting associated hash values for attachments, or if 506 the hash value was not recognized, then the attachment is retrieved 510 in a conventional manner, e.g. it is copied from the mail server. If 502 there was no attachment, then processing of the attachment ends 512.

It should be appreciated by one skilled in the art that mail clients may associated hash values (or other identifying value) with attachments on sending a mail message, and these hash values may be received by other mail clients and utilized even though intervening mail servers do not support the associated values. Thus, by associating hash values with references to attachments in a mail message, a client can use the hash value to avoid obtaining a duplicate copy of an attachment, such as the attachment in the FIG. 4 reply 414 from mail client 3 408.

FIG. 6 illustrates a flowchart according to one embodiment of the FIG. 4 system 400 for the mail server 402 to process the mail message 410 and attachment 412 send by mail client 1 404, and the reply 414 and duplicative attachment 412 sent by mail client 3 408. As discussed above, a mail client may inspect associated hash values to avoid storing duplicate attachments. A mail server 400 may also benefit from utilizing the hash values to minimize its storage requirements for storage 416.

In a typical mail system, the server stores separate copies of messages and their attachments for each recipient of the mail message, e.g., each recipient has a separate mail spool storing their copy of the message and attachment. This is wasteful of available storage 416 space, and for large attachments, many recipients, or replies the duplicate an attachment, it extra copies may compromise server stability. Some servers do attempt to reduce storage requirements when there are multiple addressees for a message, e.g., single-instance storage, where the mail server keeps only a single copy of a message's attachment, but makes it available to all addressees when they collect their mail. However, if there are different messages sent to each addressee, even servers utilizing single-instance storage will retain multiple copies of an attachment. A better approach is for the server to store a single copy of the attachment in the storage 416, and utilize hash values to track the attachments.

When the mail server receives 600 the mail message 412 and its attachment 414 from mail client 1 404, a first operation is to determine if 602 the client provided a hash value for the attachment. If not, the server determines 604 a hash value for the attachment, associates 606 the hash value with the attachment, e.g., inserts the hash value in the mail message, and stores 608 it, such as in a database or other storage tracking active hashes. If the client provided a hash value, a test is performed to determine if 610 the hash is already known. If not known, then the hash value is stored 608. If the hash is known, then the usage of the hash value is updated 612 to reflect that another mail message is using the same attachment. Such tracking is necessary to allow the server to keep a stored copy of the attachment until all messages referencing the attachment have been removed from the mail server. It will be appreciated that various Object Oriented Programming (OOP) type practices may be employed to track references to attachments.

Note that different clients may attach the same content, but where the content has different metadata, e.g., name, access times, access rights, creation date, etc., from the perspective of a particular client. Although the server may be storing only a single copy of the attachment in its storage, e.g., FIG. 4 item 416, the server may provide an attachment to an accessing mail client with the metadata intended for the accessing client. For example, if the FIG. 4 mail client 3 408 renamed the attachment, the server would still recognize the attachment as being the same as that provided by mail client 1 404, and provide the attachment to accessing mail clients under the new name. Similarly, even though the attachment has a new name, a receiving client will still recognize and retrieve 508 (FIG. 5) the local copy of the attachment.

Note also that many mail clients support HTML within mail messages, and therefore support links to resources, and a cache of previously accessed resources. As discussed above with respect to FIGS. 2 and 3, the links may be constructed to include a hash value so that a mail client can determine whether it has a current cached copy of a linked resource without having to validate a cached copy with the source server.

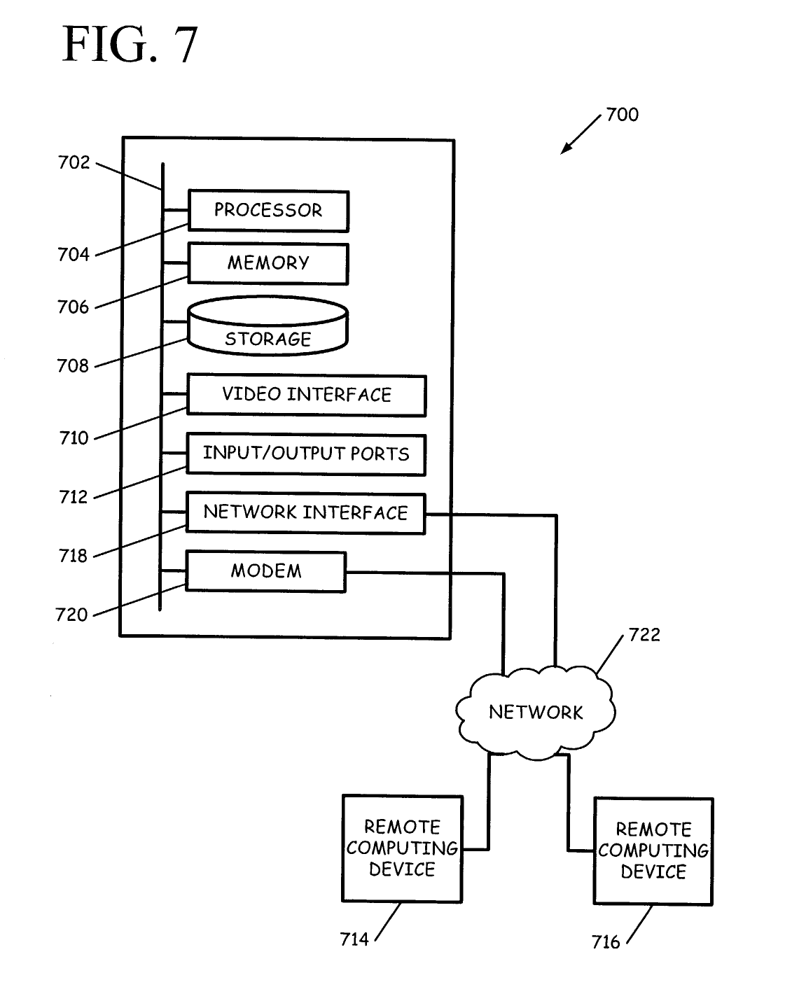

FIG. 7 and the following discussion are intended to provide a brief, general description of a suitable computing environment in which certain aspects of the illustrated invention may be implemented. For example, the illustrated environment includes a machine 700 which may embody the mail server 402 or mail clients 404-408 of FIG. 4, or the web server or web clients discussed with respect to FIG. 3. As used herein, the term “machine” includes a single machine, such as a computer, handheld device, etc., or a system of communicatively coupled machines or devices.

Typically, the machine 700 includes a system bus 702 to which is attached processors 704, a memory 706 (e.g., random access memory (RAM), read-only memory (ROM), or other state preserving medium), storage devices 708, a video interface 710, and input/output interface ports 712. The machine may be controlled, at least in part, by input from conventional input devices, such as keyboards, mice, joysticks, as well as directives received from another machine, interaction with a virtual reality (VR) environment, biometric feedback, or other input source or signal.

The machine may also include embedded controllers, such as Generic or Programmable Logic Devices or Arrays, Application Specific Integrated Circuits, single-chip computers, smart cards, or the like, and the machine is expected to operate in a networked environment using physical and/or logical connections to one or more remote machines 714, 716 through a network interface 718, modem 720, or other data pathway. Machines may be interconnected by way of a wired or wireless network 722, such as an intranet, the Internet, local area networks, and wide area networks. It will be appreciated that network 722 may utilize various short range or long range wired or wireless carriers, including but not limited to RF (radio frequency) and optical carriers.

The invention may be described by reference to or in conjunction with program modules, including functions, procedures, data structures, application programs, etc. for performing tasks, or defining abstract data types or low-level hardware contexts. Program modules may be stored in memory 706 and/or storage devices 708 and associated storage media, e.g., hard-drives, floppy-disks, optical storage, magnetic cassettes, tapes, flash memory cards, memory sticks, digital video disks, biological storage. Program modules may be delivered over transmission environments, including network 722, in the form of packets, serial data, parallel data, propagated signals, etc. Program modules may be used in a compressed or encrypted format, and may be used in a distributed environment and stored in local and/or remote memory, for access by single and multi-processor machines, portable computers, handheld devices, e.g., Personal Digital Assistants (PDAs), cellular telephones, etc.

Thus, for example, with respect to the FIG. 3 embodiment, assuming machine 700 embodies a web server providing web pages including links comprising hash values (or other identifying values), then remote machines 714, 716 may respectively be web clients receiving web pages, where the web clients inspect the link to determine cache validity without having to query the source server hosting the linked resource. Or, with respect to the FIG. 4 embodiment machine 700 may embody a mail server, where remote machines 714, 716 are mail clients that receive messages including attachments having associated hash values, where the mail clients can use the hash values to determine whether an attachment has been previously received. It will be appreciated that remote machines 714, 716 may be configured like machine 700, and therefore include many or all of the elements discussed for machine.

Having described and illustrated the principles of the invention with reference to illustrated embodiments, it will be recognized that the illustrated embodiments can be modified in arrangement and detail without departing from such principles. And, though the foregoing discussion has focused on particular embodiments, other configurations are contemplated. In particular, even though expressions such as “in one embodiment,” “in another embodiment,” or the like are used herein, these phrases are meant to generally reference embodiment possibilities, and are not intended to limit the invention to particular embodiment configurations. As used herein, these terms may reference the same or different embodiments that are combinable into other embodiments.

And, although the above description has principally relied on use of hash values to track linked resources and attachments, it will be appreciated by one skilled in the art that any value, whether hash based or not, may be used if it allows one to reliably distinguish between different content. Also, although the above description has principally discussed caching linked resources and attachments, it should be apparent to one skilled in the art that arbitrary content, including entire web pages, or portions thereof, may have associated hash values to facilitate validation of cached content.

Consequently, in view of the wide variety of permutations to the embodiments described herein, this detailed description is intended to be illustrative only, and should not be taken as limiting the scope of the invention. What is claimed as the invention, therefore, is all such modifications as may come within the scope and spirit of the following claims and equivalents thereto.

What is claimed is:

1. A method for caching resources comprising:
receiving a link to a resource, the link having a first portion identifying a remote network location hosting the resource, and a second portion including an identifier for the resource determined based at least in part on the content of the resource, the identifier being constrained such that a change to the content of the resource results in a different identifier;
looking up the identifier in an identifier storage; and
if the identifier is present in the storage, retrieving the resource from a local resource storage.

2. The method of claim 1, further comprising:
if the identifier is not present in the storage, retrieving the resource from the remote network location and storing the identifier in the storage.

3. The method of claim 1, wherein the link is received from an HTTP server, the method further comprising:
if the identifier is not present in the storage, sending the server a conditional GET request for the resource.

4. The method of claim 1, wherein the link is a Uniform Resource Locator.

5. The method of claim 1, further comprising:
receiving a web page incorporating the link.

6. The method of claim 1, wherein the resource is a selected one of an image, another web page, an email attachment, a data file, or an executable program.

7. The method of claim 1, wherein the identifier comprises a hash of the resource.

8. An article, comprising:
a machine-accessible media having associated data for caching resources, wherein the data, when accessed, results in a machine performing:
receiving a link to a resource, the link having a first portion identifying a remote network location hosting the resource, and a second portion including an identifier for the resource determined based at least in part on the content of the resource, the identifier being constrained such that a change to the content of the resource results in a different identifier;
looking up the identifier in an identifier storage; and
if the identifier is present in the storage, retrieving the resource from a local resource storage.

9. The article of claim 8 wherein the data further comprises data, which when accessed by the machine, results in the machine performing:
determining the identifier is not present in the storage;
retrieving the resource from the remote network location; and
storing the identifier in the storage.

10. The article of claim 8 wherein the data further comprises data, which when accessed by the machine, results in the machine performing:
receiving the link from a server according to the HTTP protocol;
determining the identifier is not present in the storage; and
conditionally retrieving the resource from the remote network location.

11. A method comprising:
determining an identifier for a resource determined based at least in part on the content of the resource, the identifier being constrained such that a change to the content of the resource results in a different identifier;
determining a link to the resource, the link having a first portion identifying a network location hosting the resource, and a second portion including the identifier.

12. The method of claim 11, wherein the identifier comprises a hash of the resource.

13. The method of claim 11, wherein the link is a Uniform Resource Locator.

14. The method of claim 11, further comprising:
receiving a request from a client; and
sending the link to the client responsive to the request.

15. The method of claim 11, further comprising:
receiving a web-page access from a client; and
sending a web page incorporating the link responsive to the access request.

16. The method of claim 11, further comprising:
receiving from a first client a message having the resource as an attachment;
storing a single copy of the resource in a storage indexed at least with respect to the identifier; and
configuring the message, if necessary, to incorporate the link to the resource so that multiple messages including the resource incorporate the link.

17. The method of claim 16, wherein configuring the message to incorporate the link comprises rewriting an initial link received with the message.

18. The method of claim 16, further comprising:
receiving from a second client an access request for the message; and
sending the configured e-mail message responsive to the access request.

19. An article, comprising:
a machine-accessible media having associated data for caching resources, wherein the data, when accessed, results in a machine performing:
determining an identifier for a resource determined based at least in part on the content of the resource, the identifier being constrained such that a change to the content of the resource results in a different identifier;
determining a link to the resource, the link having a first portion identifying a network location hosting the resource, and a second portion including the identifier.

20. The article of claim 19 wherein the data further comprises data, which when accessed by the machine, results in the machine performing:
receiving a request from a client; and
sending the link to the client responsive to the request.

21. The article of claim 19 wherein the data further comprises data, which when accessed by the machine, results in the machine performing:
receiving a web-page access from a client; and
sending a web page incorporating the link responsive to the access request.

22. The article of claim 19 wherein the data further comprises data, which when accessed by the machine, results in the machine performing:
receiving from a first client a message having the resource as an attachment;
storing a single copy of the resource in a storage indexed at least with respect to the identifier; and
configuring the message, if necessary, to incorporate the link to the resource so that multiple messages including the resource incorporate the link.

23. The article of claim 19 wherein the data for configuring the message to incorporate the link further comprises data, which when accessed by the machine, results in the machine performing:
rewriting an initial link received with the message.

24. The article of claim 19 wherein the data further comprises data, which when accessed by the machine, results in the machine performing:
receiving from a second client an access request for the message; and
sending the configured e-mail message responsive to the access request.

25. A system comprising:
a client configured to distribute a message having a link to a resource;
a message distribution server configured to
receive the message,
store a single copy of the resource in a storage indexed at least with respect to an identifier for the message based at least in part on the content of the resource and constrained such that a change to the content of the resource results in a different identifier, and
configure the link, if necessary, to incorporate the identifier for the resource.

26. The system of claim 25, wherein the server is further configured to:
inspect the message for the identifier; and
if the identifier is not already present in the message, then determining the identifier for the resource.

27. A system comprising:
a message distribution server configured to distribute a message having a link to a resource;
a client configured to
receive the message,
store a single copy of the resource in a storage indexed at least with respect to an identifier for the message based at least in part on the content of the resource and constrained such that a change to the content of the resource results in a different identifier, and
lookup the identifier in the storage before attempting to retrieve the resource from the message distribution server.

28. The system of claim 27, wherein the client is further configured to:
inspect the message for the identifier; and
if the identifier is not already present in the message, configuring the link to incorporate the identifier for the resource.
